(19) United States
(12) Patent Application Publication
(10) Pub. No.: US 2015/0163540 A1
(43) Pub. Date: Jun. 11, 2015

(54) Bandwidth Reclamation Using IP Infrastructure For Video Content Delivery

(71) Applicant: Zenverge, Inc., Santa Clara, CA (US)

(72) Inventor: Anthony D. Masterson, Saratoga, CA (US)

(73) Assignee: Zenverge, Inc., Santa Clara, CA (US)

(21) Appl. No.: 14/099,547

(22) Filed: Dec. 6, 2013

(51) Int. Cl. H04N 21/4363; H04N 21/426; H04N 21/61; H04N 21/438; H04N 21/4408; H04N 21/4402

(52) U.S. Cl. CPC H04N 21/4363; H04N 21/4408; H04N 21/440218; H04N 21/44029; H04N 21/6125; H04N 21/4382; H04N 21/42653

(57) ABSTRACT

A content delivery gateway receives a video sequence transmitted over an Internet Protocol network and the video sequence is destined to multiple digital display devices. The content delivery gateway transcodes the video sequence into one of multiple video formats, e.g., high efficiency video coding (HEVC) format to advanced video coding (AVC) format, HEVC OR AVC to MPEG-2 format. The content delivery gateway generates an IP-based user interface including video overly that allows existing quadrature amplitude modulation (QAM) based set-top boxes and digital TV adapters to receive features associated with IP video technology. The content delivery gateway further adds content protection by transcripting the video sequence. By deploying IP to QAM bridges, the content delivery gateway serves increasingly large numbers of IP-based digital display devices including tablets and smartphones while continuing to support existing QAM-based display devices.

### BACKGROUND

1. Field of Art

The disclosure generally relates to digital multimedia content delivery, more particularly, to a video content delivery gateway that deploys IP video technology with high efficiency video coding (HEVC), advanced video codec (AVC or H.264) and MPEG-2 compatibility to a variety of consumer electronics devices, set-top boxes (STBs) and digital television adapters (DTAs).

2. Description of the Related Art

More and more digital multimedia content, e.g., digital video and digital audio, is now being delivered over Internet Protocol (IP) networks such as the Internet. Video transmitted over the IP networks is generally referred to as “IP video,” and technology that enables IP video transmission and application is called “IP video technology.” IP video technology provides cable providers and other video service providers multiple advantages over current quadrature amplitude modulation (QAM) technology, which is used to encode digital cable channels and to transmit the encoded channels to cable subscribers. For example, IP video technology enables cable providers to serve the growing array of IP-enabled consumer electronics devices, especially mobile devices. With IP video technology, cable providers can provide new and better video services, such as efficient video broadcasting and better search and navigation user experiences, to their subscribers.

Delivering high quality video content using IP infrastructure to cable subscribers is challenging for cable providers and is often at the expense of unacceptable high cost and degraded user experience. For example, replacing currently existing tens of millions QAM set-top boxes (STBs) and digital television adapters (DTAs) of cable subscribers with IP-enabled recording/displaying devices will be costly to cable providers and inconvenient to their subscribers. Further, upgrading video delivery quality using more advanced video compression technologies, such as high efficiency video coding (HEVC) and AVC coding standards, will require yet another significant investment by cable providers including the cost of conversion between different coding standards/formats.

Figure (FIG. 2 illustrates an environment of currently existing video content delivery infrastructure and challenges faced by video service providers. The video service provider in the environment illustrated in FIG. 2 is a cable provider, where QAM/Cable Modem Termination System (CMTS) 210 at the headend of the cable provider stores and provides a hybrid of QAM video and IP video for cable subscribers using a variety of STBs. The QAM/CMTS 210 stores and provides QAM video 230 for QAM based STBs (e.g., 260a-260b) and DTAs (e.g., 260c-260d) over its backbone network. QAM video 230 are video encoded using quadrature amplitude modulation technology for existing QAM STBs and DTAs. The QAM/CMTS 210 may also store and provide IP/Data over Cable Service Interface Specification (DOCSIS) video 240 to IP-enabled STBs (e.g., 250a-250c). Unlike the existing QAM STBs and DTAs, IP-enabled STBs generally do not require a separate Cable-Card to operate. The video content 230/240 is delivered to a delivery bridge 220 that is connected to the STBs/DTAs 250/260 used by subscribers of the cable provider. An example of the delivery bridge 220 is cable modems, e.g., DOCSIS 3.0 cable modems, which deliver the video content and other data services to the subscribers and provide wireless home networking to the subscribers.

As video service providers transition to IP only infrastructure and support more efficient multimedia content delivery and rich multimedia features (e.g., using HEVC or AVC compression), the video service providers need to find a solution to support increasingly large number of IP-based consumer electronics devices for IP video, e.g., IP STBs, while continuing to serve the millions of existing QAM based STBs and DTAs.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2 illustrates an environment of currently existing infrastructure of video content delivery to consumer electronic devices.

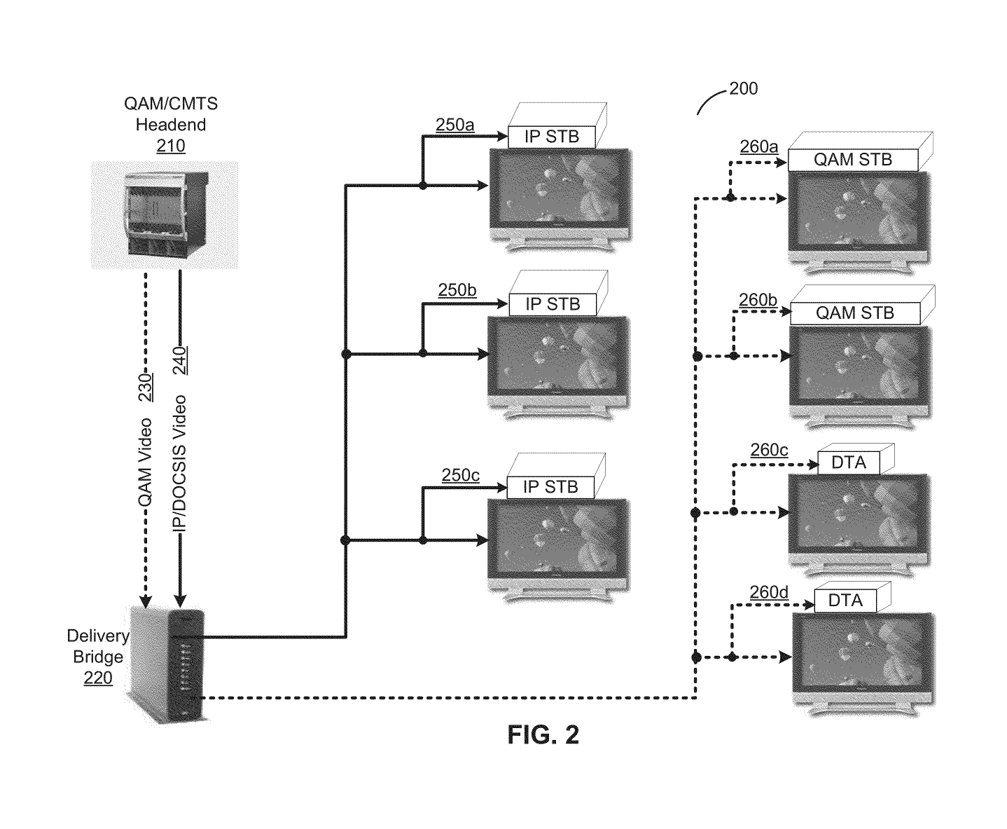

FIG. 3 is a system view of a content delivery gateway that supports IP video services and efficient video coding compatibility according to one embodiment.

FIG. 4 illustrates an example of integration of a content delivery gateway that delivers IP video with high video coding efficiency compatibility to a variety of display devices according to one embodiment.

FIG. 5 is a block level illustration of a gateway engine of the content delivery gateway illustrated in FIG. 3 and FIG. 4 according to one embodiment.

FIG. 6 is a block flowchart of deploying IP to QAM bridges with enhanced user experience according to one embodiment.

FIG. 7 is a flowchart of deploying IP to QAM bridges for video content delivery according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

To deliver video content over an IP only infrastructure to an increasing number of IP-enabled consumer electronics devices and millions of existing QAM STBs, a content delivery gateway is provided to deploy IP video technology to QAM bridges with MPEG-2, AVC and HEVC compatibility and upgraded user interfaces on the existing QAM STBs and DTAs. One embodiment of the content delivery gateway as disclosed receives IP video from a video content service provider and transcodes the video into one of multiple video formats. Video transcoding provides video adaptation in terms of bit-rate reduction, resolution reduction and format conversion to meet various requirements for display on a subscriber's display device.

The content delivery gateway also transcodes audio data associated with the video. One embodiment of the content delivery gateway as disclosed transcodes an audio stream encoded in one audio codec to an output audio stream in another audio codec. The transcoded output audio stream has an acceptable sound quality and conforms to the memory or other hardware configuration of the subscriber's display device for playback or the bandwidth of the communication link between the display device and the content delivery gateway.

To enrich user experiences receiving the video content delivered to their QAM based display devices, the content delivery gateway is connected to the display devices and generates IP-based user interface video overlay on users' QAM STBs and DTAs. The content delivery gateway secures the content delivery by transcrypting the transcoded video and audio content using a variety of digital content encryption/decryption schemes. In this disclosure, “transcrypting” generally refers to a computer process that changes digital encryption for a piece of digital content. To support currently existing QAM based STBs and DTAs, the content delivery gateway modulates the transcoded video and audio content for display on the QAM based STBs and DTAs.

### Computing Machine Architecture

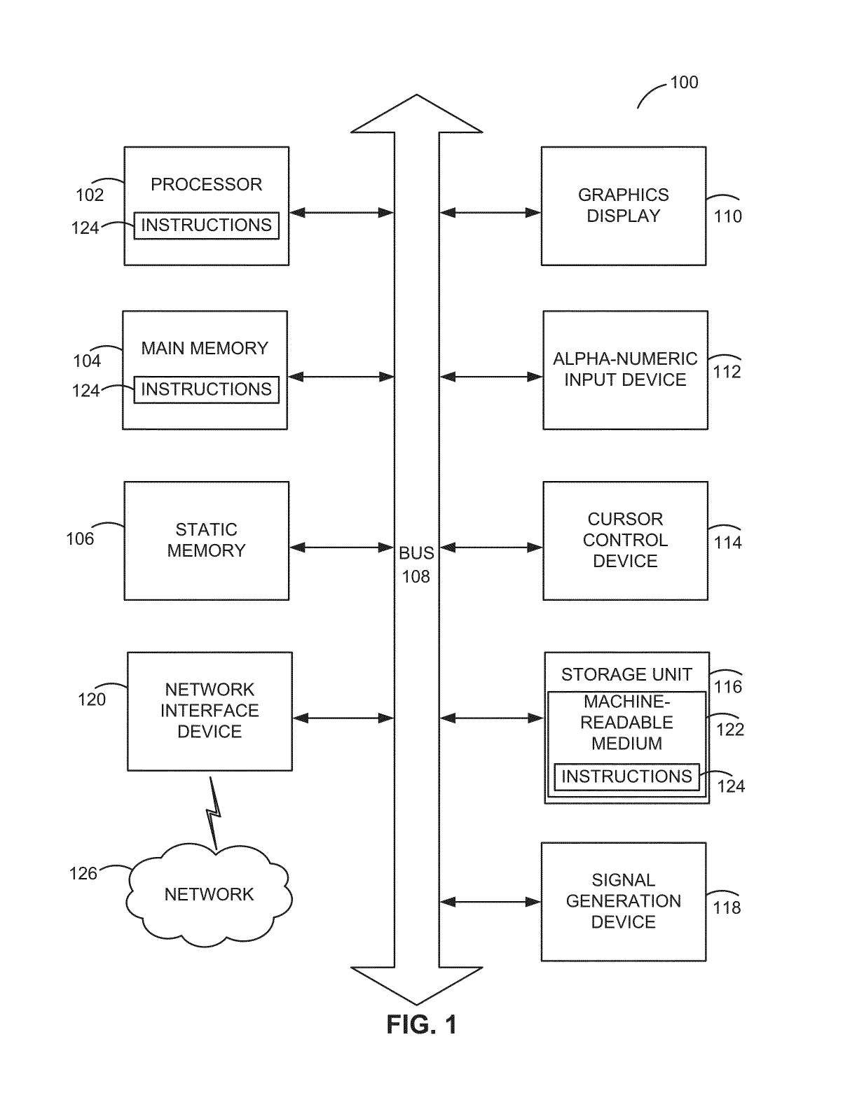

Referring now to FIG. 1, illustrated is a block diagram showing components of an example machine able to read instructions from a machine-readable medium and execute them in a processor (or controller). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes one or more processors (generally processor 102) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 120, which also are configured to communicate via the bus 108.

The storage unit 116 includes a machine-readable medium 122 (e.g., non-transitory computer-readable storage medium) on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### Video Content Delivery Using Ip-to-Qam Content Delivery Gateway

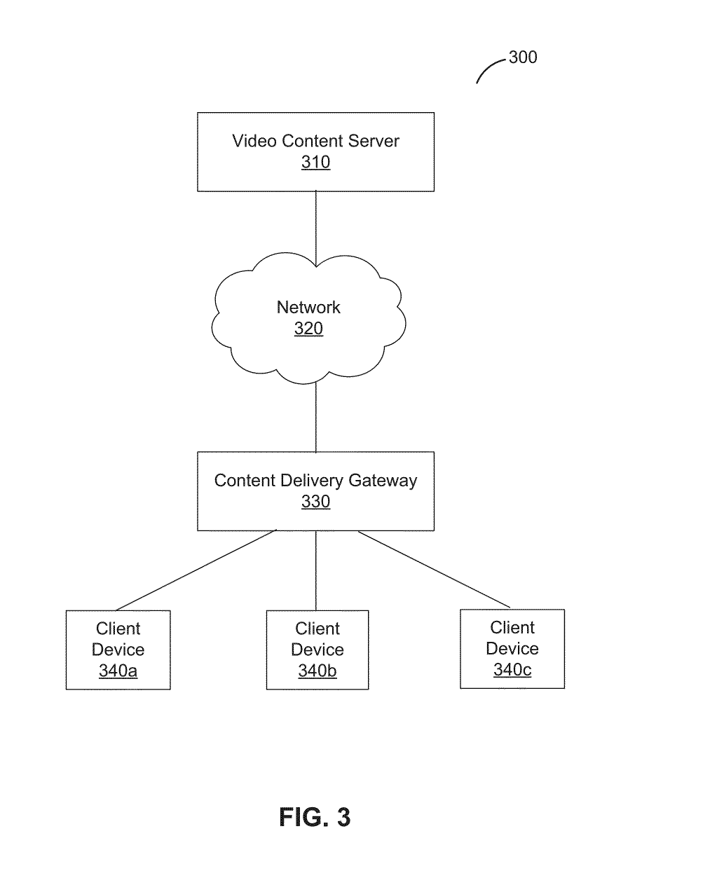

FIG. 3 is a system view of a content delivery gateway 330 that supports IP video services and efficient video coding compatibility to client devices 340 according to one embodiment. The environment 300 illustrated in FIG. 3 includes a video content server 310 and a content delivery gateway 330 connected by a network 320. The content delivery gateway 330 is configured to receive video from the video content server 310, to process the received video and to deliver the video to one or more client devices 340.

In one embodiment, the video content server 310 functions as a cable modem termination system (CMTS) at the headend of a cable provider. The video content server 310 is configured to provide high speed digital data services, such as video, audio and data over IP networks, to its cable subscribers. Taking video data to be transmitted over the Internet (i.e., IP video) as an example, the video content server 310 provides IP video destined for one or more display devices of cable subscribers and encapsulates the IP video data packets according to DOCSIS standard for the transmission over the Internet.

The network 320 enables communications between the various entities of the environment 300. In one embodiment, the network 320 uses standard communications technologies and/or protocols. Thus, the network 320 can include links using technologies such as Ethernet, WiFi (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 320 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 320 can be represented using technologies and/or formats including the hypertext markup language (HTML), the extensible markup language (XML), JavaScript Object Notation (JSON) etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above. Depending upon the embodiment, the network 320 can also include links to other networks such as the Internet.

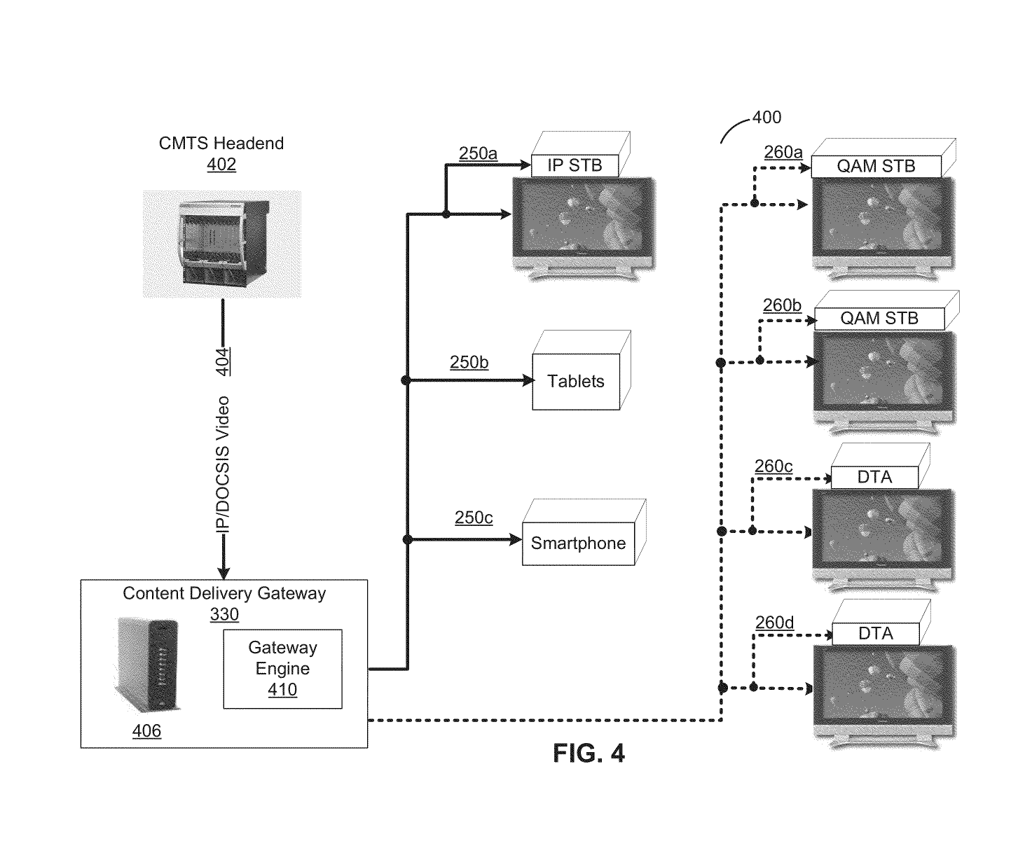

The content delivery gateway 330 illustrated in FIG. 3 is configured to process video content data and to deliver the processed video content data to multiple client devices 340 of a cable subscriber. One embodiment of the video content delivery gateway 330 is a standalone IP-to-QAM bridge converter box that sits on coax of a video service subscriber's premise. The video content delivery gateway 330 is connected to a cable modem (not shown in FIG. 3) and has interfaces to support digital multimedia over coax alliance (MoCA), QAM, Ethernet and/or WiFi services to the display devices of the subscriber. Another embodiment of the video content delivery gateway 330 is a fully integrated IP-to-QAM bridge that includes the functionalities provided by cable modems (e.g., DOCSIS 3.0 modems) in addition to interfaces to support MoCA, QAM, Ethernet and WiFi services to the display devices of the subscriber. The content delivery gateway 330 is further described with references to FIG. 4-FIG. 6 below.

The client devices 340a, 340b and 340c (hereon collectively referred to as “client device 340”) are used by video service subscribers and are configured to receive and display video content delivered by the content delivery gateway 330. Only three client devices 340 are shown in FIG. 1 for purposes of clarity, but those skilled in the art will recognize that typical environments can have varying numbers of client devices 340. In one embodiment, the client device 340 is a QAM based STB connected to the cable subscriber's TV and client device 340 only receives modulated video data in MPEG-2 format. In another embodiment, the client device 340 is a television tuner, e.g., a DTA, connected to the cable subscriber's analog TV and converts the digital data signal into an analog signal that can be displayed on the analog TV.

In yet another embodiment, the client device 340 is an IP-enabled consumer electronic device, such as an IP-based STB, and is configured to receive video data encoded in advanced video coding standards. For example, an IP-based STB is a small computer that provides two-way communications on an IP network and decodes video streaming data. The IP-based STB has a built-in home networking interface, e.g., Ethernet, MoCA or WiFi, which provides a way to create a high-speed local area network using coaxial cables at a cable subscriber's premise. Compared with conventional QAM based STBs, the IP based STBs generally do not require cable-card to operate.

FIG. 4 illustrates an example of integration of the content delivery gateway 330 that delivers IP video with high efficiency video coding (HEVC) and AVC compatibility to a variety of display devices according to one embodiment. In the example illustrated in FIG. 4, the integration includes a CMTS system 402 of a cable provider, a content delivery gateway 330 and a variety of consumer display devices, e.g., IP-enabled STBs 250 and existing QAM based STBs and DTAs 260. The CMTS system 402 provides IP video 404 to a variety of consumer display devices through the content delivery gateway 330. The content delivery gateway 330 receives the video 404 from the CMTS system 402, converts the video 404 into appropriate network traffic and delivers the processed video 404 to the display devices 250 and 260.

In one embodiment, the CMTS system 402 supports DOCSIS 3.0 standard for video transmission over the IP-based backbone of the CMTS system 402. The CMTS 402 communicates with a DOCSIS compatible modem 406, e.g., a DOCSIS 3.0 modem, of the content delivery gateway 330 to deliver the video 404. A CMTS system typically carries only IP data traffic, such as IP video 404. The CMTS system encapsulates the IP traffic destined for a cable modem from the Internet, also known as downstream traffic, in IP packets according to the DOCSIS standard. The DOCSIS modem 406 modulates the downstream traffic of the video data 404 onto a cable TV channel using quadrature amplitude modulation, e.g., 64-QAM or 256-QAM. The content delivery gateway 330 further processes the video 404, such as transcoding the video and audio associated with the video for the delivery, overlays a new user interface, handles channel change, removing and adding encryption, converts video resolution for HD to SD as needed, and supports ABR multiscreen viewing on tablets and smartphones.

Responsive to the CMTS system 402 delivering IP video 404 to the consumer display devices through the content delivery gateway 330, the content delivery gateway 330 converts the IP video 404 into IP unicast traffic that can be distributed to IP-enabled STBs 250 or other IP-based consumer electronics devices. These IP-enabled STBs are generally smaller in size than existing QAM STBs and do not require a separate cable card to operate. In one embodiment, the content delivery gateway 330 integrates MoCA 1.1 and/or WiFi technology that enable the distribution of high quality digital multimedia content, e.g., IP video 404, throughout a subscriber's home over existing coaxial cable to their IP-enabled STBs. The content delivery gateway 330 further processes the IP video 404, such as transcoding the video and audio associated with the video content for the delivery.

### Content Delivery Gateway—Gateway Engine

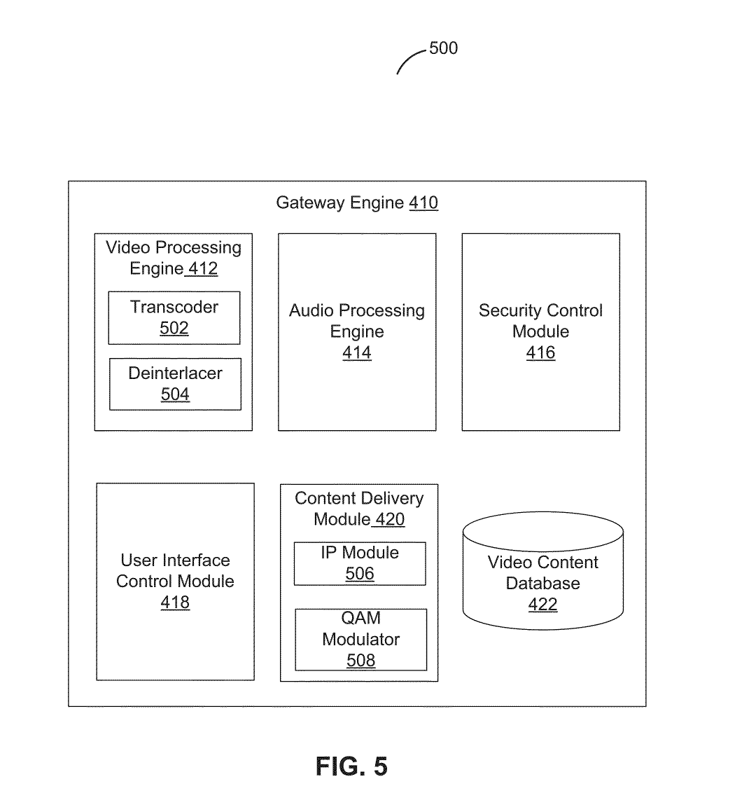

FIG. 5 is a block level illustration of a gateway engine 410 of the content delivery gateway 330 according to one embodiment. In the embodiment illustrated in FIG. 5, the gateway engine 410 includes a video processing engine 412, an audio processing engine 414, a security control module 416, a user interface control module 418, a content delivery module 420 and a video content database 422. The gateway engine 410 receives a video destined for one or more consumer display devices, e.g., tablets, smartphones, QAM STBs, DTAs or IP-enabled STBs, processes the video and delivers the video to its destination.

The video processing engine 412 is configured to process a video received from a cable provider. In one embodiment, the video processing engine 412 comprises a video transcoder 502 and a deinterlacer 504. Other embodiments of the video processing engine 412 may include additional video processing modules, such as modules for supporting adaptive bitrate multiscreen viewing for IP-enabled consumer electronics devices.

The video transcoder 502 is configured to transcode an input video stream into an output video stream in one or more video formats suitable for display on the display devices of a cable subscriber. One type of the video transcoding is transcoding a video coded in high efficiency video coding (HEVC) standard to a video in advanced video coding (AVC) format responsive to the display device of the subscriber being IP-enabled STBs. The IP-enabled STBs can be used directly for TV and for streaming digital content in a subscriber's premise across coaxial cables using MoCA standard.

As the new HEVC video coding standard coming into co-existence with the widely adopted H.264/AVC standard, video coded in HEVC standard need to be converted into AVC format to play on AVC compatible devices. For example, without HEVC to AVC transcoding, a high definition HEVC digital TV program cannot be displayed on a mobile phone that supports only AVC. To provide the widely deployed H.264/AVC devices with HEVC video content, the video transcoder 502 transcodes HEVC video into video in H.264/AVC format. Any existing video transcoding scheme for HEVC to AVC transcoding, such as intra and inter frame transcoder with fast prediction mode decision, can be used with the embodiments of the video transcoder 502.

Another type of transcoding performed by the video transcoder 502 is transcoding HEVC OR AVC video to video in MPEG-2 format for the video to be played on legacy MPEG-2 compatible devices, such as MPEG-2 STBs and DTAs. Although more and more digital video content is coded using newer and more efficient coding standards, e.g., H.264/AVC or HEVC, many existing consumer displaying devices, such as home TV receivers and digital TVs, still use older coding standard, such as MPEG-2. The video transcoder 502 transcodes HEVC/AVC video into video in MPEG-2 format. Any existing video transcoding scheme for HEVC OR AVC to MPEG-2 transcoding can be used with the embodiments of the video transcoder 502.

Most modern digital TVs have a digital turner built in, which enables a cable subscriber to watch digital channels on his/her TV, but those who still have analog TVs need to use a set-up box. A standard definition (SD) STB can only access standard definition channels. In one embodiment, the video transcoder 502 also converts high definition (HD) video to SD video in response to STBs and DTAs only supporting video in SD resolution. Other embodiments of the video transcoder 502 transcode video into other video formats, resolutions and bitrates.

In addition to video transcoding, the video transcoding engine 412 is also configured to enhance video processing performance in multiple ways. In one embodiment, the video processing engine 412 has a motion adaptive deinterlacer 504. To effectively convert an interlaced video, such as 1080i format high-definition TV (HDTV) signals, into progressive format for progressive devices (e.g., tablets, smartphones, laptops, plasmas display or projection TV), motion adaptive deinterlacing balances tradeoff of computational complexity and high quality. One embodiment of the deinterlacer 504 receives four or more interlaced fields from the input video stream. The deinterlacer 504 filters noise of the received interlaced fields using a blur filter (e.g., a 3×3 Gaussian filter). The deinterlacer 504 detects edges of the received interlaced fields with a Sobel operator. From the detected edges, the deinterlacer 504 spatially interpolates an output pixel using directional filtering to select among multiple possible directions using the direction which provides the smallest difference between the spatial neighboring pixels of an output pixel.

The deinterlacer 504 also detects motion of the output pixel based on the four or more input fields of the input video stream. The deinterlacer 504 calculates temporal constraints of the output pixel based on same parity field difference and/or opposite parity field difference. To reduce inaccurately detected motion, the deinterlacer 504 calculates the temporal constraint based on opposite parity field difference to detect finger like patterns and horizontal thin lines. Based on the temporal interpolation and spatial interpolation of the output pixel, the deinterlacer 504 blends the temporal and spatial interpolation of the output pixel to generate an output pixel in progressive format. A further description of embodiments of motion adaptive deinterlacing is provided in U.S. patent application Ser. No. 13/618,536, which is incorporated by reference in its entirety herein.

As fully IP-based infrastructure becomes widely adopted for digital content delivery and the number of audio codecs continues to increase, audio transcoding becomes an integral part of efficient digital content delivery and enhanced user experience. In one embodiment, the audio processing engine 414 is configured to transcode an audio stream associated with an input video stream. For example, the audio processing engine 414 transcodes an audio stream coded by an AC-3 codec, to an AAC output audio stream. The transcoded output audio stream has an acceptable sound quality and conforms to the memory or other hardware configuration of the subscriber's display device for playback or the bandwidth of the communication link between the display device and the content delivery gateway 330. Any existing audio transcoding scheme can be used with the embodiments of the audio processing module 414.

To provide protection of IP video transmitted over the Internet, video content providers often encrypt the IP video using a digital content encrypting mechanism, such as Digital Video Broadcasting (DVB), DigiCipher2. In one embodiment, the gateway engine 410 includes a security control module 416 to decrypt and/or encrypt video processed by the gateway engine 410. The security control module 416 deploys a digital content encrypting mechanism, e.g., DigiCipher2, to perform real time encryption of of video data in an AVC or MPEG-2 transport stream format. The security control module 416 can insert encryption key and management information within each transport stream for efficient decryption of the video by existing QAM STBs.

To further enhance user search and navigation experiences with IP video displayed on the user's display devices, the gateway engine 410 has a user interface (UI) control module 418. In one embodiment, the UI control module 418 provides graphics overlay on top of the video to be displayed. Layering graphics such as still images, text or animations on top of an uncompressed video signal allows a viewer to navigate viewing menus, setup screens, alerts, program information, digital watermarks or other graphics layered on the uncompressed video signals without interrupting the video stream. This significantly improves the user experience over the existing UI in the QAM STB or DTA.

In one embodiment, the UI control module 418 receives a command from a remote set-top box coupled to a display. The command instructs the UI control module 418 to include layering graphics planes on the video stream being processed by the video processing engine 412. The UI control module 418 generates a composite graphics plane by layering multiple graphics planes and communicates with the video processing engine 412 to include the generated composite graphics plane on the transcoded video stream. A further description of embodiments of video overlay is provided in U.S. patent application Ser. No. 11/851,924 and U.S. patent application Ser. No. 13/900,027, which are incorporated by reference in their entirety herein.

In one embodiment, the UI control module 418 supports IP multicast architecture and viewing customization by generating an enhanced user interface. The enhanced UI, e.g., a customized UI based on X2 graphical UI standard, allows a user to customize a homepage dashboard with user selected applications and titles that match the user personal viewing habits. For example, the UI control module 418 may generate a UI that includes more social content such as content quality evaluation scores or warnings related to age-appropriate content.

The content delivery module 420 of the gateway engine 410 is provided to deliver video processed by the gateway engine 410. In one embodiment, the content delivery module 420 comprises an IP module 506 and a QAM modulator 508. The IP module 506 is for delivering video to be displayed on IP-enabled STBs, e.g., IP STBs 250 illustrated in FIG. 4. The IP modules 506 communicates with the IP-enabled STBs and provides information needed for the IP-enabled STBs to decode video to be displayed on a display device, e.g., digital TV. In one embodiment, the information provided by the IP modules 506 includes information of video encryption and/or decryption and communication protocols for communicating with the built-in home networking interface, e.g., Ethernet, MoCA or WiFi.

The QAM modulator 508 of the content delivery module 420 is for delivering video to be displayed on QAM based STBs and DTAs. In one embodiment, the QAM modulator 508 is a 4 channel QAM modulator configured to send digital video and/or audio signals of the video processed by the gateway engine 410 up to 4 QAM STBs or DTAs on 4 adjacent channels. For example, the QAM modulator 508 uses a 64- or 256-QAM scheme and MPEG-2 transport packets to transmit downstream signals for digital TV applications.

The video content database 422 of the gateway engine 410 stores video processed by the gateway engine 410. In one embodiment, the gateway engine 410 receives IP/DOCSIS video from a video content provider and stores the video in the database 422. The various modules of the gateway engine 410 retrieve the video for processing and store the processed video in the database 422 for delivery. For example, the video processing engine 412 of the gateway engine 410 retrieves the video for transcoding and deinterlacing. The audio processing engine 414 transcoding the audio associated with video. The security module 416 decrypts a video received from a video content provider and encrypts the processed video for delivery to cable subscribers. The user interface control module 418 further processes the video by adding a video overlay or generates an enhanced UI for a user to interact with the displayed video. The content delivery module 420 retrieves the processed video from the database 422 and delivers them to the cable subscribers.

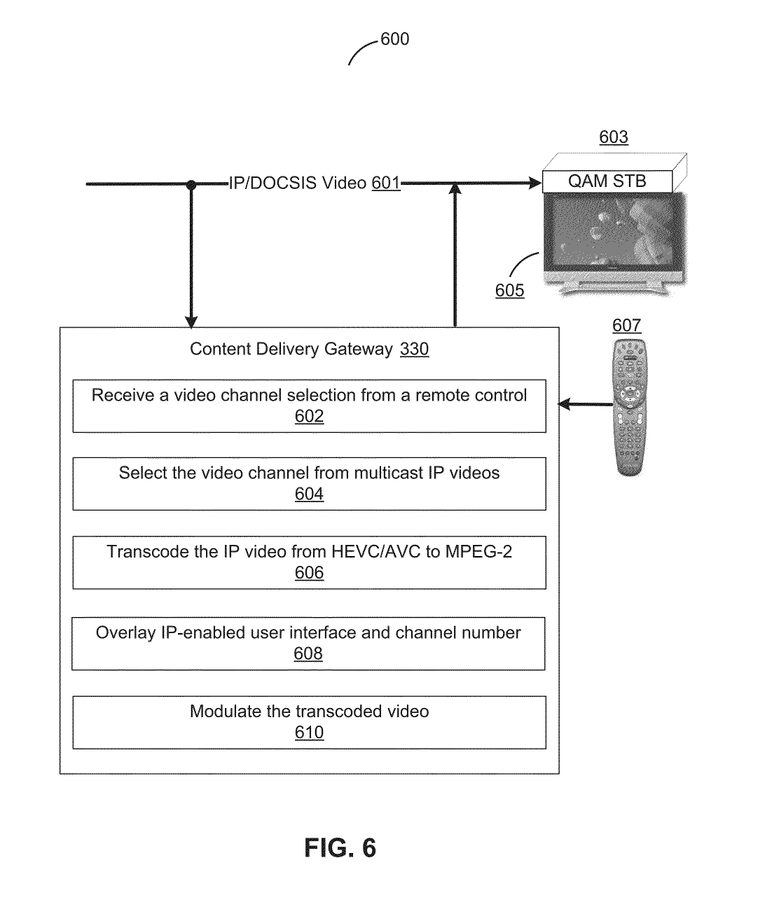

FIG. 6 is a block flowchart of deploying IP to QAM bridges with enhanced user experience according to one embodiment. The content delivery gateway 330 receives IP/DOCSIS video 601 from a video content provider, such as a cable provider. The IP/DOCSIS video 601 are destined to a subscriber of the content provider. In one embodiment, the IP/DOCSIS video 601 is multicast IP video encoded in HEVC and/or AVC format. The subscriber has a QAM based STB 603 connected to an analog or digital TV 605 and a remote control 607. In the embodiment illustrated in FIG. 6, the content delivery gateway 330 is located at the subscriber's premise and is implemented as a separate IP-enabled display device that communicates with the STB 603, TV 605 and the remote control 607 for delivering the IP/DOCSIS video 601.

The content delivery gateway 330 receives 602 a video channel selection from the remote control 607, e.g., a Zigbee remote control. The content delivery gateway 330 selects 604 the video channel from the IP multicast video and transcodes 606 the video of the selected video channel from HEVC OR AVC format to a video in MPEG-2 format. To enhance the user experience for high quality IP multicast video, the content delivery gateway 330 overlays 608 an IP-enabled user interface on the decoded video signals to be displayed on the TV 605. To support backward compatibility, the content delivery gateway 330 modulates 610 the transcoded video prior to the delivery and delivers the modulated video to the STB 603. To provide fast channel change to a cable subscriber, the content delivery gateway 330 modulates the transcoded video for a single QAM STB on a single channel that doesn't change so there is no longer any QAM tuner delay.

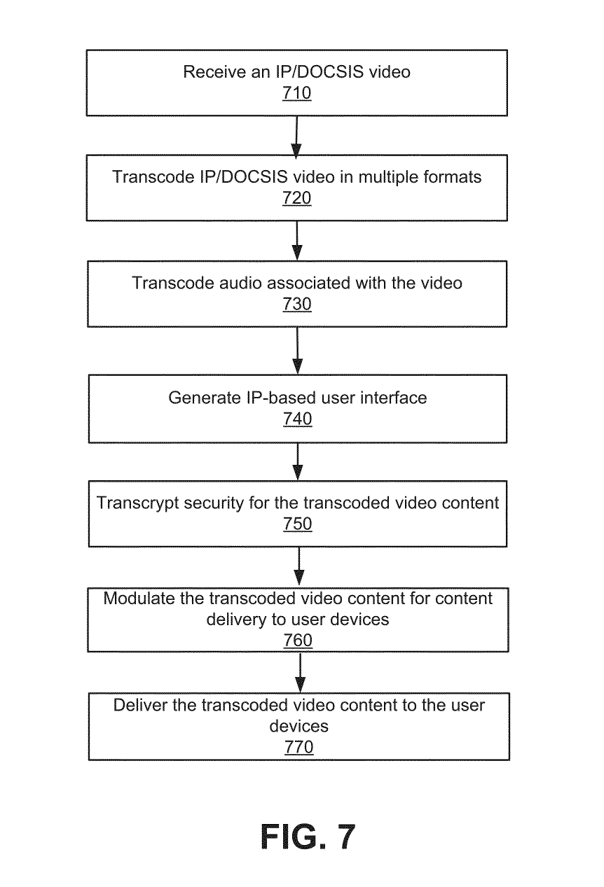

FIG. 7 is a flowchart of deploying IP to QAM bridges for video content delivery according to one embodiment. Initially, the content delivery gateway 330 receives 710 an IP/DOCSIS video from a content provider. The IP/DOCSIS video is a broadcast video encoded in accordance with advanced video coding standards, such as HEVC and AVC, and the IP/DOCSIS video is transmitted over IP networks, such as the Internet. The content delivery gateway 330 selects a desired IP video stream from the IP broadcast video based on wireless remote control. The content delivery gateway 330 transcodes 720 the received video into one or more video formats, such as HEVC-to-AVC transcoding, HEVC-to-MPEG-2 transcoding and AVC-to-MPEG-2 transcoding. Additionally, the content delivery gateway 330 may transcode the received video into a different resolution or bitrate. The content delivery gateway 330 also transcodes 730 audio associated with the video.

To enhance user experience with the IP/DOCSIS video, the content delivery gateway 330 generates 740 an IP-based user interface. The IP-based UI can be implemented as a video overly on the decoded IP/DOCSIS video to be displayed on the subscriber's display device. Responsive to the IP/DOCSIS video being encrypted, the content delivery gateway 330 transcrypts 750 the video, e.g., decrypting the video and re-encrypting the video, to add protection of the processed IP/DOCSIS video. Although there are an increasing number of IP-enabled consumer display devices, e.g., IP-based STBs and DTAs, there are still millions of conventional QAM based STBs and DTAs, which are configured to receive video coded with older video coding standards, e.g. MPEG-2. The content delivery gateway 330 modulates 760 the transcoded video to support backward compatibility and delivers 770 the transcoded video content to the subscriber.

### Application of Deploying IP to QAM STBs Via a Content Delivery Gateway

The disclosed embodiments of deploying IP video to QAM-based STBs and DTAs beneficially allow for a system and methods for delivering an input video stream to one or more video content service subscribers. Deploying IP video to QAM-based STBs via a content delivery gateway enables delivery of video content over an IP only infrastructure to an increasing number of IP-enabled consumer electronics devices while supporting millions of existing QAM STBs. For example, the content delivery gateway delivers video transmitted over IP networks to subscribers with HEVC compatibility and upgraded user interfaces on the existing QAM STBs and DTAs via transcoding and video overlay. The content delivery gateway secures the content delivery by transcrypting the video and audio content using a variety of digital content encryption/decryption schemes.

### Additional Configuration Considerations

It is noted that example embodiments of the video content delivery gateway provide the following video content delivery services to consumers:
Transcoding HEVC video to video compressed by AVC standard for new IP-enabled AVC STBs and DTAs;
Transcoding HEVC OR AVC video to MPEG-2 video for MPEG-2 compatible STBs and DTAs;
Converting HD video to SD video for SD STBs and DTAs;
Providing IP-enabled user interface video overlay for QAM based STBs and DTAs;
Encrypting transcoded video and audio content with security protocols, e.g., DigiCipher2;
Supporting multiple wireless remote controls, e.g., Zigbee remote controllers;
Enhancing user experience with fast channel change feature for existing QAM STBs and DTAs; and
Supporting adaptive bitrate multiscreen viewing for IP-enabled consumer electronics devices, e.g., tablets and smartphones.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, e.g., as shown and described in FIG. 5. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods, e.g., described with FIG. 7, may be performed, at least partially, by one or more processors, e.g., 102, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented, e.g., processor 102. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors, e.g., 102, may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory 104). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for deploying IP to QAM bridges for efficient video content delivery through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for delivering a video sequence transmitted over an Internet Protocol (IP) networks to a plurality of digital display devices, the method comprising:
receiving a video sequence transmitted over an IP network;
transcoding the video sequence, the transcoded video sequence suitable for display on at least one of the plurality of digital display devices;
transcrypting the transcoded video sequence; and
delivering the transcrypted video sequence to the plurality of digital display devices.

2. The method of claim 1, further comprising transcoding an audio stream associated with the video sequence.

3. The method of claim 1, wherein transcoding the video sequence comprises:
responsive to the video sequence being coded with in high efficiency video coding (HEVC) format and one of the plurality digital display devices configured to receive a video sequence coded in advance video coding (AVC) format, transcoding the video sequence coded in HEVC format to an output video sequence in AVC format.

4. The method of claim 1, wherein transcoding the video sequence further comprises:
responsive to the video sequence being coded in advance video coding (AVC) format and one of the plurality digital display devices configured to receive a video sequence coded in Moving Picture Experts Group (MPEG-2) format, transcoding the video sequence coded in AVC format to an output video sequence in MPEG-2 format.

5. The method of claim 1, wherein transcoding the video sequence further comprises:
responsive to the video sequence being coded in efficiency video coding (HEVC) format and one of the plurality digital display devices configured to receive a video sequence coded in Moving Picture Experts Group (MPEG-2) format, transcoding the video sequence coded in HEVC format to an output video sequence in MPEG-2 format.

6. The method of claim 1, further comprising:
generating an IP-based user interface for a remote control of at least one of the digital display devices, the IP-based user interface configured to provide features supported by Internet protocols.

7. The method of claim 6, wherein generating an IP-based user interface comprises:
generating a graphics overlay on top of the transcoded video sequence, the graphics overlay comprising a plurality of graphics planes.

8. The method of claim 1, wherein the plurality of digital displaying devices comprise at least one quadrature amplitude modulation (QAM) based set-top box and at least one IP-enabled set-top box.

9. The method of claim 1, further comprising:
responsive to at least one of the plurality of digital display devices being a quadrature amplitude modulation (QAM) based set-top box, modulating the transcoded video sequence.

10. A non-transitory computer-readable storage medium storing computer program instructions, executed by at least a processor, for delivering a video sequence transmitted over an Internet Protocol (IP) networks to a plurality of digital display devices, the computer program instructions comprising instructions to:
receive a video sequence transmitted over an IP network;
transcode the video sequence, the transcoded video sequence suitable for display on at least one of the plurality of digital display devices;
transcrypt the transcoded video sequence; and
deliver the transcrypted video sequence to the plurality of digital display devices.

11. The computer-readable storage medium of claim 10, wherein the computer program instructions for transcoding the video sequence comprise computer program instructions to:
transcode the video sequence coded in HEVC format to an output video sequence in AVC format in response to the video sequence being coded with in efficiency video coding (HEVC) format and one of the plurality digital display devices configured to receive a video sequence coded in advance video coding (AVC) format.

12. The computer-readable storage medium of claim 10, wherein the computer program instructions for transcoding the video sequence further comprise computer program instructions to:
transcode the video sequence coded in AVC format to an output video sequence in MPEG-2 format in response to the video sequence being coded in advance video coding (AVC) format and one of the plurality digital display devices configured to receive a video sequence coded in Moving Picture Experts Group (MPEG-2) format.

13. The computer-readable storage medium of claim 10, wherein the computer program instructions for transcoding the video sequence further comprise computer program instructions to:
transcode the video sequence coded in HEVC format to an output video sequence in MPEG-2 format in response to the video sequence being coded in efficiency video coding (HEVC) format and one of the plurality digital display devices configured to receive a video sequence coded in Moving Picture Experts Group (MPEG) 2 format.

14. The computer-readable storage medium of claim 10, further comprising computer program instructions to:
generate an IP-based user interface for a remote control of at least one of the digital display devices, the IP-based user interface configured to provide features supported by Internet protocols.

15. The computer-readable storage medium of claim 14, wherein the computer program instructions for generating an IP-based user interface comprise computer program instructions to:
generate a graphics overlay on top of the transcoded video sequence, the graphics overlay comprising a plurality of graphics planes.

16. The computer-readable storage medium of claim 10, wherein the plurality of digital displaying devices comprise at least one quadrature amplitude modulation (QAM) based set-top box and at least one IP-enabled set-top box.

17. The computer-readable storage medium of claim 10, further comprising computer program instructions to:
modulate the transcoded video sequence in response to at least one of the plurality of digital display devices being a quadrature amplitude modulation (QAM) based set-top box.

18. A computer system for delivering a video sequence transmitted over an Internet Protocol (IP) networks to a plurality of digital display devices, the system comprising:
a processor; and
a non-transitory computer-readable storage medium storing computer program instructions, executed by the processor, the computer program instructions comprising instructions for:
receiving a video sequence transmitted over an IP network;
transcoding the video sequence, the transcoded video sequence suitable for display on at least one of the plurality of digital display devices;
transcrypting the transcoded video sequence; and
delivering the transcrypted video sequence to the plurality of digital display devices.

19. The computer system of claim 18, wherein the computer program instructions for transcoding the video sequence comprise computer program instructions for:
transcoding the video sequence coded in HEVC format to an output video sequence in AVC format in response to the video sequence being coded with in efficiency video coding (HEVC) format and one of the plurality digital display devices configured to receive a video sequence coded in advance video coding (AVC) format.

20. The computer system of claim 18, wherein the computer program instructions for transcoding the video sequence further comprise computer program instructions for:
transcoding the video sequence coded in AVC format to an output video sequence in MPEG-2 format in response to the video sequence being coded in advance video coding (AVC) format and one of the plurality digital display devices configured to receive a video sequence coded in Moving Picture Experts Group (MPEG-2) format.

21. The computer system of claim 18, wherein the computer program instructions for transcoding the video sequence further comprise computer program instructions for:
transcoding the video sequence coded in HEVC format to an output video sequence in MPEG-2 format in response to the video sequence being coded in high efficiency video coding (HEVC) format and one of the plurality digital display devices configured to receive a video sequence coded in Moving Picture Experts Group (MPEG-2) format.

22. The computer system of claim 18, further comprising computer program instructions for:
generating an IP-based user interface for a remote control of at least one of the digital display devices, the IP-based user interface configured to provide features supported by Internet protocols.

23. The computer system of claim 22, wherein the computer program instructions for generating an IP-based user interface comprise computer program instructions for:
generating a graphics overlay on top of the transcoded video sequence, the graphics overlay comprising a plurality of graphics planes.

24. The computer system of claim 18, wherein the plurality of digital displaying devices comprise at least one quadrature amplitude modulation (QAM) based set-top box and at least one IP-enabled set-top box.

25. The computer system of claim 18, further comprising computer program instructions for:
responsive to at least one of the plurality of digital display devices being a quadrature amplitude modulation (QAM) based set-top box, modulating the transcoded video sequence.
